(19) United States
(12) Patent Application Publication
(10) Pub. No.: US 2018/0176179 A1
(43) Pub. Date: Jun. 21, 2018

(54) Data Ferry Systems, Devices and Methods

(71) Applicant: Michael L Froelich, Austin, TX (US)

(72) Inventor: Michael L Froelich, Austin, TX (US)

(21) Appl. No.: 15/888,001

(22) Filed: Feb. 3, 2018

Related U.S. Application Data
(63) Continuation-in-part of application No. 14/545,832, filed on Jun. 25, 2015.
(60) Provisional application No. 62/020,127, filed on Jul. 2, 2014.

(51) Int. Cl. H04L 29/06

(52) U.S. Cl. CPC H04L 63/02; H04L 63/14

(57) ABSTRACT

A computing machine, methods and devices for operating a data ferry as a secure data link from a secured computer not connected to a WAN network to a browser computer with Internet connectability, in which the two computers share a housing and connections to shared peripherals. The secured computer can distribute “disposable” copies of data files and programs via the browser computer over an unsecure network without the risks of data sharing and collaboration via the Internet. The data ferry is essentially a unidirectional databus configured for transmitting data, files, images and executable code from the primary computer to the buffer computer. In a preferred embodiment, a shared monitor and circuit-switched router can be used for example for videoconferencing or browser input in an unsecured computing environment while also referencing and editing secured documents at the same time in a secured computing environment.

### CROSS REFERENCE TO RELATED APPLICATIONS

This application is a Continuation-in-Part of U.S. patent application Ser. No. 14/545,832 filed 25 Jun. 2015, which claims priority to U.S. Provisional Patent Application No. 62/020,127, filed 14 Jul. 2014. Said patent documents are herein incorporated in full by reference for all purposes.

### GOVERNMENT SUPPORT

Not Applicable.

### TECHNICAL FIELD

Systems, devices and methods for computer network security.

### BACKGROUND

Connecting computers to networks has always contained the risk that the systems could be penetrated with unwanted code during any digital exchange. With the advent of the Internet this security problem has become extremely serious. Unlike previous networks in which a limited number of computers were interconnected, with the Internet there are so many computers on-line from so many different locations that the security problems have become unmanageable and a threat to an open society. The advantages of a global network include sharing data, archives, reference libraries and work product with others. The disadvantages, however, are numerous. Users quickly discovered that by so doing they exposed their computers to various unwanted code from state and non-state users on the Internet. While self-replicating viral code is as old as ARPANET, the first to infect personal computers is believed to have emerged in 1981 and infected boot sectors floppy disks. In 1986, the first PC virus emerged in epidemic form (Lahore Virus) and spread from Pakistan around the world. In response, the first commercial antiviral program was released in 1987. The viruses may be highly “contagious”—it took only 10 min for the SQL Slammer Worm to go pandemic in 2003. In this context, the “browser war” between Netscape and Microsoft's embedded browser flared in 1996 and in 1998, Google launched its first search engine. Since Y2K, the growth of viruses has been exponential, and as many as one third of the world's home computers are thought to shelter some form of virus, either dormant or actively using private computer resources as part of a botnet for commission of crimes or espionage. These self-propagating forms of unwanted code, termed “malware”, can spread using the Internet and perform unwanted, dangerous and destructive functions. Viral payloads also diversified, and now are configured to distributed denial of service (DDoS), ransomware, rootkits, many forms of malicious, unwelcome or amoral activities, and even as cyber weapons that can result in physical damage (such as Stuxnet and Skywiper) as well as damage to, theft, or loss of intellectual property of all kinds (termed in the spy trade, “exploits”, but also including industrial espionage, loss of trade secrets, and so forth, without limitation).

This sad state of affairs was never necessary. If users such as individuals, governments, institutions and businesses had fully considered the early warnings, they would not now connect computers containing vital or sensitive files or programs to the Internet and would carefully monitor hotspots contained in laptops and the like. It has always been possible, with care, to keep their computers un-connected to the Internet but to share data by using a second computer having an Internet connection, and then transferring data from the un-connected computer (known clean) to the browser computer, unidirectionally, by a variety of secure external means such as disks or flashdrive devices having defined permissions. In this way such devices can be loaded with data from the clean computer (un-connected to the Internet) and then the device data may be accessed by an un-secure browser computer directly connected to a network, so as to create a file that can be distributed via the Internet. A hardwired disconnect can be used to keep certain sensitive computers un-connected to the Internet and yet allow unidirectional data from those computers to be shared. If governments, institutions, businesses and individuals had done this then there would be little, if any, of the security problems which have been created by open or even passworded networking. However, this is inconvenient and has not generally been done.

Thus a related problem is the physical inconvenience of relying on external data transport systems such as sanitized flashdrives or disks to move data or files from a first computer connected to a net to a second “off-net” computer un-connected to the Internet or to a “private” network, including “virtual private networks” (VPN), if such actually exist.

Given this background, there is a need in the art for a system that overcomes the disadvantages of the current “wipe and patch” approach to software immunization, an “arms race” between hackers and legitimate programmers where one is always a step ahead of the other.

### SUMMARY

The purpose of the invention is to end or reduce security risks stemming from computer networking by making unidirectional digital data transfer convenient and safe. Having two computers in two different cases is not as convenient as having the two computers paired into a single case. Having a single case saves room, is more modular and less redundant, and allows for ease of use and portability without the need for complicated rewiring.

My invention divides all computers into two types. A first or “primary type” are computers in which valuable or sensitive programs and files reside in a secured computing environment. These computers are used by individuals, governments, institutions, utilities, etc., and businesses for their vital functions. These vital computers should never be connected to the Internet, and are not connected to the Internet in my invention. The second type of computer is a computer dedicated for Internet use. These “browser” or “buffer” computers store no valuable or necessary programs or files but are configured to navigate the Internet and as such are understood to be exposed to all manner of risks of infection. This second computer will accumulate unwanted code from the Internet but at intervals as needed will be wiped clean of all code and the needed code, including any browser software and data sharing code, will be re-installed fresh. The computer which is connected to the Internet serves the purpose of a browser computer which only operates Internet functions. The user operates the browser computer or system using an attached or an integrated user interface having a keyboard, voice recognition, touch or pointer control module to input data and a display module.

However, within the same computer case is also a second computer, the secured or “primary” computer, which is never connected to the Internet. This primary computer of is provided with substantial computing power, speed, memory storage, and other facilities such that it is suitable for use for the user's many non-Internet functions. These functions are conducted by segregated programs and software. These functions relate to everything required of the computer and the programs operated to meet the user's core needs, be the user an individual, a company, a business, a government, an institution, or any other kind of organization or individual. This primary computer possesses no network interface or port, and cannot be connected to the Internet, wiredly or wirelessly.

Each computer has at least one separate processor dedicated for its use alone. Generally, the primary computer and the browser computer have a shared, common input user interface with router for addressing one or the other separate processor and a separate graphical user interface having separate controllers but share a common display screen, either by partitioning of the screen or by overlay technologies known in the art.

The user operates the primary computer for the user's needed functions and in so doing from time to time creates work product or files consisting of data which the user wants to port to the Internet for distribution to others or for publication. To do this safely, a one-way data transfer link is provided from the primary computer to the browser computer. The user simply uses the keypad and screen shared by the two computers, or pair of systems, to operate the one-way data transfer link. The user employs the keypad and screen as controls to load data files from the primary computer into the data transfer device, or ferry. Once the intended files are loaded into the device, or ferry, the device disconnects from the primary computer ferries the data mechanically or electronically to the browser computer system by attaching to it and loading the intended data files into it. The data ferry may be (1) mechanical with prime mover, operating manually in the manner of a throw switch, or it may be (2) electromechanical, having an electronic and a controller for physically disconnecting a buffer device to and from each computer, with one connection at a time, it may be (3) solid state, having an in silico latch that handles unidirectional data transfer on command of an interface controller either in the data ferry device or in the primary computer, or may be an optical device. It may have serial or parallel bus interconnects and internal memory, where the browser computer is configured as a slave to the data ferry or a slave to the primary computer. The configuration involves one or more interrupts on the processor of the browser computer, both computers, and may also involve a microcontroller or processor on the data ferry unit or module itself.

As stated above, computer users almost always use the same computer for Internet/intranet use as for all their other sensitive or confidential uses. When they use their computers with sensitive files and data stored therein for Internet/intranet use they open their sensitive files to examination, exfiltration, corruption or destruction by others who penetrate their computers. The common methods to counter-measure such penetrations such as the use of firewalls and software to counter access of files or disk storage are ineffective and costly. Embodiments of the invention claimed here solves this problem.

These and other elements, features, steps, and advantages of the invention will be more readily understood upon consideration of the following detailed description of the invention, taken in conjunction with the accompanying drawings, in which presently preferred embodiments of the invention are illustrated by way of example, and in the claims.

### BRIEF DESCRIPTION OF THE DRAWINGS

The teachings of the inventive art disclosed here are more readily understood by considering the drawings in conjunction with the written description including the claims, in which:

FIG. 1 is a schematic of a computing machine (10) having a primary and a buffer computing machine that are joined by a data ferry in a single housing or “case”, that share one keyboard and monitor, and in which a wireless transceiver connects the buffer computing machine to the Internet.

FIG. 2 is a schematic of a computing machine (11) with wired connection to the internet.

FIG. 3 is a block diagram of a computing machine with a data ferry, keyboard and mouse data router, and a monitor data node or router in a shared housing, also sharing connections to typical peripherals.

FIGS. 4A, 4B, 5A, 5B, and 5C are views of cyclical and streaming data transfer methods based on electrical, optical or optoelectronic data ferry devices

FIG. 5D is a view of a video feed comparator for validating data transfer.

FIG. 6 is a detail view of a data ferry unit having a separate microcontroller, RAM buffer memory, a databus, and an address bus.

FIGS. 7A and 7B are two parts of one schematic view of a second embodiment of the invention having a standard keyboard and monitor in which the data ferry, in addition to a latch and memory buffer function, also includes a user interface data router for directing two graphical processor units.

FIG. 8 is a flow chart showing a general method for processing email using the computing machine combination of FIGS. 7A-7B.

FIG. 9 is a view of a generic Internet-enabled device, here represented by a smart phone having a data ferry of the invention bridging a browser unit and a secured computing environment within the device.

The drawing figures are not necessarily to scale. Direction of motion or coupling of views may be shown by bold arrows or boxed figures without further explanation where the meaning would be obvious to one skilled in the arts. Certain features or components herein may be shown in somewhat schematic form and some details of conventional elements may not be shown in the interest of clarity, explanation, or conciseness. It is to be expressly understood that the drawings are for illustration and description only and are not intended as a definition of the limits of the invention.

### DETAILED DESCRIPTION

Although the following detailed description contains specific details for the purposes of illustration, one of skill in the art will appreciate that many variations and alterations to the following details are within the scope of the claimed invention. The following glossary is set forth as an aid in explaining the invention as claimed.

### Glossary and Notation

Certain terms are used throughout the following description to refer to particular features, steps or components, and are used as terms of disclosure and not of limitation. As one skilled in the art will appreciate, different persons may refer to the same feature, step or component by different names. Components, steps or features that differ in name but not in structure, function or action are considered equivalent and not distinguishable, and may be substituted herein without departure from the invention. Certain meanings are defined here as intended by the inventors, i.e., they are intrinsic meanings. Other words and phrases used herein take their meaning as consistent with usage as would be apparent to one skilled in the relevant arts. The following definitions supplement those set forth elsewhere in this specification.

“Computer” means a physical computing machine that accepts information in digital or similar form and manipulates it for a specific result based on a sequence of instructions. “Computing machine” is used in a broad sense, and may include logic circuitry having a processor, programmable memory or firmware, random access memory, and generally one or more ports to I/O devices such as a graphical user interface, a pointer, a keypad, a sensor, imaging circuitry, a radio or wired communications link, and so forth. One or more processors may be integrated into the display, sensor and communications modules of an apparatus of the invention, and may communicate with other microprocessors or with a network via wireless or wired connections known to those skilled in the art. Processors are generally supported by static (programmable) and dynamic memory, a timing clock or clocks, and digital input and outputs as well as one or more communications protocols. The comprehensive term “computing machine” includes desktop computers and devices such as “smart devices” generally, including telephones, tablets and laptops where an Internet browser is housed next to a secured computing resource in need of protection.

“Processor” refers to a digital device as part of a “computing machine” that accepts information in digital form and manipulates it for a specific result based on a sequence of programmed instructions. Processors are generally supported by non-volatile memory (for storage of programmable instructions, e.g., ROM) and dynamic memory (e.g., RAM), a timing clock or clocks, and digital input and outputs as well as one or more communications protocols. One or more processors may be integrated into the display, calculation, sensor and communications modules of an apparatus of the invention, and may communicate with other microprocessors or with a network via wireless or wired connections known to those skilled in the art. Processors may interface with other digital devices or with analog devices through I/O ports, for example.

“Adapted to” includes and encompasses the meanings of “capable of” and additionally, “designed to”, as applies to those uses intended by the patent. In contrast, a claim drafted with the limitation “capable of” also encompasses unintended uses and misuses of a functional element beyond those uses indicated in the disclosure. Aspex Eyewear v Marchon Eyewear 672 F3d 1335, 1349 (Fed Circ 2012). “Configured to”, as used here, is taken to indicate is able to, is designed to, and is intended to function in support of the inventive structures, and is thus more stringent than “enabled to”.

General connection terms including, but not limited to “connected,” “attached,” “linked,” “coupled,” “conjoined,” “secured,” “mounted”, and “affixed” are not meant to be limiting, such that structures so “associated” may have more than one way of being associated. “Digitally connected” indicates a connection for conveying a digital signal therethrough; “electrically connected” indicates a connection for conveying or sensing a current or a voltage therethrough; “electromagnetically connected” indicates a connection or linkage for conveying or sensing a Coulombic or Lorentz force therethrough; “mechanically connected” indicates a connection, mechanical stack, or linkage for conveying or sensing a force therethrough; fluidly connected” indicates a connection for conveying a fluid therethrough, and so forth.

Relative terms should be construed as such. For example, the term “front” is meant to be relative to the term “back,” the term “upper” is meant to be relative to the term “lower,” the term “anterior” is meant to be relative to the term “posterior,” the term “vertical” is meant to be relative to the term “horizontal,” the term “top” is meant to be relative to the term “bottom,” and the term “inside” is meant to be relative to the term “outside,” and so forth. Unless specifically stated otherwise, the terms “first,” “second,” “third,” and “fourth” are meant solely for purposes of designation and not for order or for limitation.

It should be noted that the terms “may,” “can,” and “might” are used to indicate alternatives and optional features and only should be construed as a limitation if specifically included in the claims. The various components, features, steps, or embodiments thereof are all “preferred” whether or not specifically so indicated. Claims not including a specific limitation should not be construed to include that limitation. For example, the term “a” or “an” as used in the claims does not exclude a plurality.

“Conventional” refers to a term or method designating that which is known and commonly understood in the technology to which this invention relates.

When describing the claimed inventions, unless the context requires otherwise, throughout the specification and claims that follow, the term “comprise” and variations thereof, such as, “comprises” and “comprising” are to be construed in an open, inclusive sense—as in “including, but not limited to.” Further, the appended claims are not to be interpreted as including means-plus-function limitations, unless a given claim explicitly evokes the means-plus-function clause of 35 USC § 112 para (f) by using the phrase “means for” followed by a verb in gerund form.

### DETAILED DESCRIPTION

My invention prevents anyone from accessing sensitive files or data on a computer through the internet or other external sources through structural architecture of the computer making protective measures such as anti-penetration software unnecessary. By placing within one computer case two independent sets of microprocessors and drives, one termed a “secured computer”, the other a “buffer computer” or “browser computer”, the two of which are structurally separate, the secured computer can be used manipulate and store sensitive files and executable with no direct connection to the outside through the internet or other means. The browser computer with microprocessor/drive is unconnected to the secured computer and can be used to access the internet and other vulnerable outside means. To allow the user to send data or files from the secured computing environment to the unsecured computing environment, a one-way data ferry is made. One way of creating a secure data ferry is to load a data drop connected to the secured system which can then be disconnected from it and then travel to the unsecured system, connect to it, and unload or download the data it conveys. Then before the data drop, or ferry, is re-connected to the secured system it can be wiped completely clean so no data from the unsecured system is transferred to the secured system.

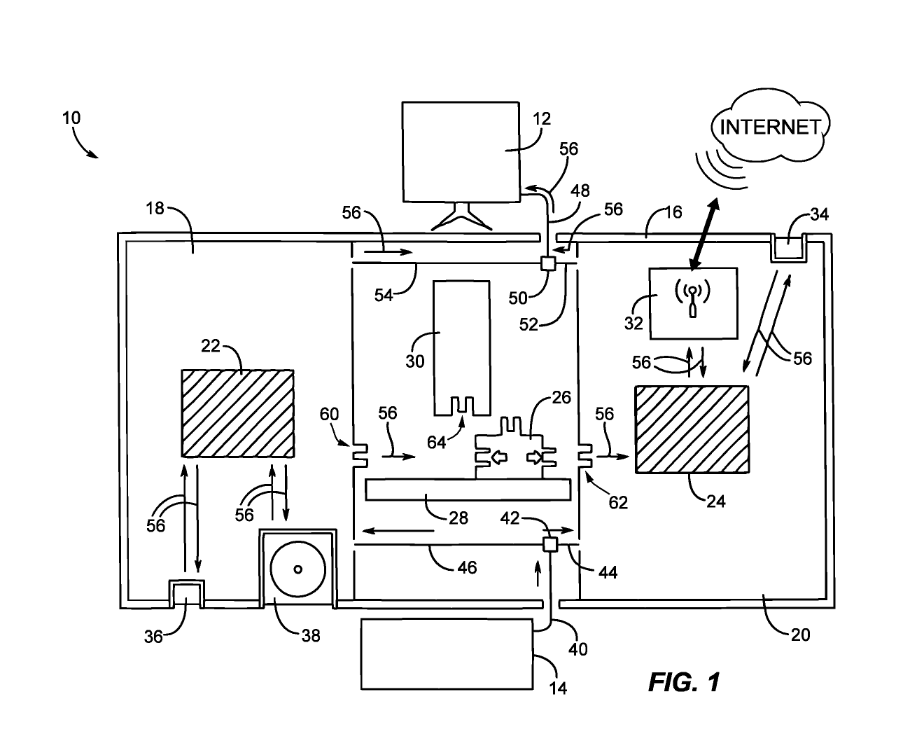

In FIG. 1, a computing machine 10 includes a secured computer 18 (left) and a browser computer 20 (right) in shared computer case 16. Each computer includes an independent CPU with hard drive, graphics processing unit (GPU), and requisite software, shown here in block form (22,24). While termed a “browser computer”, the means for accessing the Internet need not be a software browser, but instead may be an ASIC or a card in a slot that functions to interpret Internet Protocol (TCP/IP) code contained in packet-switched data. Also shown are a shared monitor 12 and keyboard 14.

The keyboard is wired 40 to a keystroke router 42, which directs keystrokes to the secured computer 18 or the browser computer 20 according to a selection made by the operator. In a preferred embodiment, the keystroke router is directed by a switch mounted in the keyboard, but router switching may also be under mouse control, or under control of a haptic interface, for example. In a more complex implementation, the keystrokes are directed by detecting sustained eye movements, and a buffer may be used so as to capture keystrokes while computing machine 10 is detecting the intent of the operator. In yet another embodiment, the router is a repeater, and keystrokes may be used to edit a document in the secure environment on the left, while a copy of the document is edited simultaneously on the right in the browser computer 24, or vice versa. The direction of keyboard data flows to the secure computing environment and the unsecure computing environment are labelled (44,46).

In the middle is a schematic of a data ferry 26, here illustrated as a mechanical device with conveyance apparatus 28, although implementations may also be optical or electrical. Digital data flows are labelled 56 to show direction of flow from connection 60 to connection 62 when not disconnected. Reverse flow of data (and current) is prevented. Operation of the data ferry is directed only from the secured computer in current practice, so as to allow users to add password, biometric identifier requirement, or other security barriers to insider data theft, but the data ferry can also be configured to be operated from either computing environment. The direction of data flows through the data ferry from the secure computing environment to the unsecure computing environment are labelled 56.

At the top of the figure is a monitor data node 50, with video and audio data flows (52,54) from the secure computing environment and the unsecured computing environment as selected by the operator so as to be copacetic with operation of the keyboard. Generally, this is automatic and is handled in the GPU associated with each computer according to operator intent. However, a split screen or a screen within a screen may also be displayed, such as for video conferencing in an unsecure browser window while multitasking to edit a document in the secure computing environment. When editing in both computers simultaneously, generally only one version of the document will be displayed and changes made to that version will be mirrored in the version on the other computer. In this way, edits made in the unsecured computing environment can be captured in secure memory.

Included in the case around the secured computing environment are a USB port 36 and compact disk reader/writer 38, as examples, ports that are generally regarded as secure when used with secure USB and CD media, for example. The secured computer may also support an ethernet connector to a private local router for porting to local printers, scanners, and other local devices that are not operated on a DHCP platform susceptible to external intrusion. The browser computer is illustrated with a network connector 34 such as for a LAN connection and a wireless card 32 for connection to a wide area network (WAN) such as the Internet. The case and port connections, devices and cables are generally grounded and a power supply is shared between the two systems in the case 16.

The data ferry functions to load an internal memory when connected to the secured system and to ferry (i.e., transfer) the memory contents to the browser computer when connected, and not vice versa. In between transfers, the data ferry is generally disconnected from connection 62. In a preferred embodiment, the data ferry memory may be sanitized before a next cycle of transfer begins with loading the memory at connection 60. Sanitation device 30 is configured to capture the data ferry at connection 64 on each return cycle and to drain or overwrite the memory. Optionally, data can also be erased during the copy process at connection 62. In an electronic latch, the speed of cycling the data ferry can be faster than the operator's speed and has the assurance of data integrity. Connections 60, 62, and 64 are preferably electronic or optophotonic and are disconnectable when not connected to the data ferry “circuit” or latch. Optionally, the data ferry can transfer data in a one-way stream, and can operate without an internal memory, speeding operation. Data, like current, flows down a voltage drop that may be hard wired to prevent reverse data transmission, but data ferry connections can also include a diode or diodes to ensure one-way flow of data.

The data ferry can also function to restore the browser computer to a clean state when contaminated with unwanted code or applications. The browser computer may include a separate memory for storing user names, identities and other information that access is needed to. So reloading the operating system and applications into the browser computer drive from a pristine master copy in the secured computer can be handled by the data ferry as an automatic block operation. The secured memory can be updated from secured sources of new applications and updates as needed under careful scrutiny to prevent tampering with the process.

A routine practice of sanitizing the entire browser computer memory in RAM and even the bios can be best practice for critical data. During routine use, the computer user is only exposing the unsecured system drive/processor/accompanying software to penetration from outside and corruption, breach, or interception of a limited set of data copies. Only the unsecured system need be cleaned in order to purge it of unwanted code while the secured system remains pristine.

The computing machine may be organized into subsystems: the secured drive/processor system 22 with accompanying software; the unsecured drive/processor system 24 with accompanying software, the data ferry apparatus (26,28) with memory and connections (60,62), and the data ferry sanitation device 30 with connection 64 to the data ferry 26 and any accompanying software if needed.

The cycling of the data ferry can then be conceived as a process of transferring data from the secured system drive/processor/accompanying software at connection 60 and receiving data from it. Once the data ferry has received the data it disconnects from 60 and is physically, electronically, or optically connected at 62 to the unsecured system drive/processor/accompanying software, where data files are unloaded and are then available for attachment to emails, for example, and can be used in collaborations on the Internet. Once the data ferry has unloaded its data in the unsecured computing environment, it is disconnected and then is automatically wiped clean of all data in the data ferry sanitation device under control of a sanitation daemon, a software routine, or firmware.

In electromechanical systems, once the browser computer has received the data then the ferry device disconnects from the browser computer system, and any buffer memory on the ferry device is automatically wiped clean of all data. Once all data has been cleaned or purged from the ferry memory then it moves back for to reconnect to the primary computer system so it may receive another load of data for transfer.

In solid state and optoelectronic systems, the latch may or may not use a buffer memory, but the latch is set up so that data flows at a rate defined by a clock in the primary computer, browser computer, or in the latch device itself, and there is no need to wipe the system because the latch is connected such that reverse data flow to the primary computer is physically impossible in the solid state circuits of the databus.

Display porting may be achieved through separate cards in each system that are generally linked to separate data and video address buses or may be achieved with a video card or processor having a dual feed including one input from a video bus to the primary computer and another input from a video bus to the buffer computer. Much of the video is generated internally in the card from on-board libraries of fonts and pixel color charts, and addressing can be dual channel or overlayered single channel to the monitor so that there is a shared pixel address system. The dual and overlayered display requires little if any timing or frame control that would necessitate direct interconnects between the processors. Compatible graphics cards useful in the invention are within the capacity of current manufacturing suppliers. A chip that operates the display or a video card itself is often termed a graphical processor unit (GPU). GPU's may be quite sophisticated, for example, as contemplated here, may be configured to drive a video display from a raw stream of TCP-IP-compatible packet-switched data received directly from a browser unit without a CPU as an intermediate. In other words, the GPU may be highly autonomous, almost as if a computer in itself.

Where a mouse or pointer is shared, a router is needed so that control is shared and only one mouse or pointer is needed. Pointers may include haptic sensors, capacitive screens, voice recognition display, pupil tracking systems, and conventional mouse devices, all of which are known in the art. The needed modifications are made in the data ferry and do not require customization of the mouse or pointer to be compatible with the systems of the invention. In a preferred configuration, a screen cursor can be moved seamlessly between display addresses relating to the primary computer and display addresses relating to the browser computer.

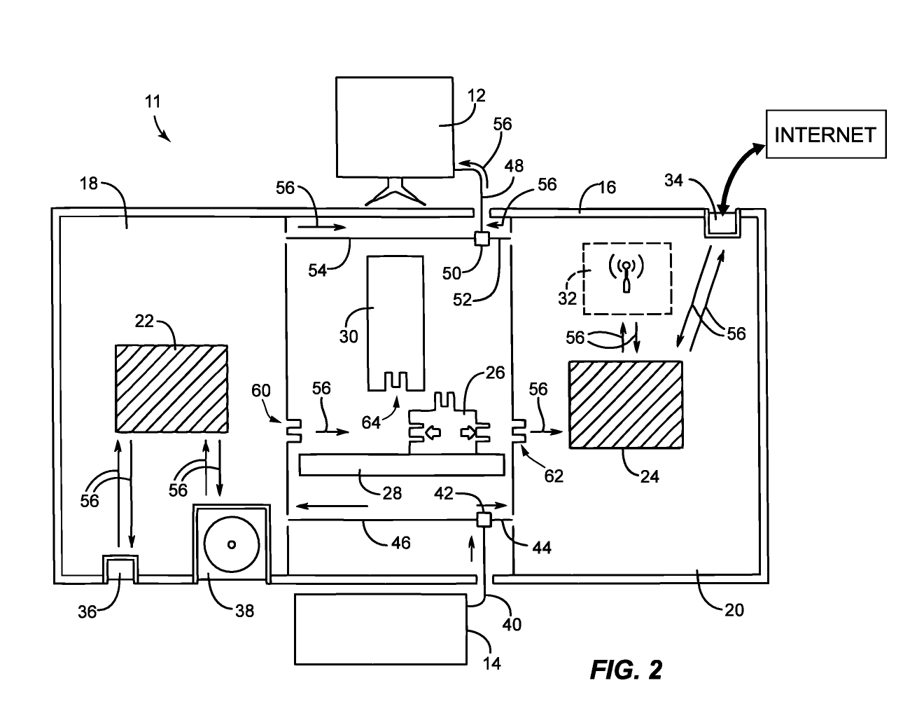

FIG. 2 illustrates a computing machine 11 with data ferry system connected to a broad area network via a wired connection. The wireless board 32 is optional. Wired and wireless networks may be established from the unsecured computer using the Internet Protocol, and wired networks (or their optical equivalents) may also be established from the secured computer. Thus the computing machines of the invention may serve as hubs for local networks operating without risk of data breach.

The user can use the Internet with the browser computer, which contains essentially no sensitive programs or files. When the browser computer gets loaded down with unwanted code the user can simply wipe it clean of all code. But within the same case and using the same keypad and screen is the user's secured computer, in which the user maintains vital programs and files not intended to be exposed to the Internet.

Internet file architecture as launched by Richard Licklider, Robert Kahn, and Vinton Cerf includes four layers (Application, Transport, Internet, and Network Interface) for joining heterogeneously structured networks into a world network. The browser computer is enabled to process files structured according to the Internet Protocol. The TCP/IP packet-switched data of the Internet is not peer-to-peer or point-to-point, and by virtue of its promiscuity from network to network, leads to bot nets and data breaches. However, in the computing machines of the invention, hacking is no longer profitable because the browser computer is easily wiped and restored to its native state, contains little or no sensitive data, and cannot be used to attack operators' secure operating systems on the secured computer.

### How to Make a First Embodiment of the Invention

In a first embodiment, take the internal mechanisms of two computers: their hard drives and accompanying processors, and assemble them into two independent computing systems installed into a single computer case with a single keyboard and screen. Then give each of the two systems of drives and processors its own software so that they can be independently operated from the same keyboard, mouse or screen. Create a data ferry by installing a data memory device between the two systems, and construct a mechanism for the ferry and/or its contained data to be moved or conveyed so as to be connected and disconnected between the two systems. Make sure that the memory device, or data ferry, cannot be connected to both systems at the same time. Design the conveyance for the memory device, or data ferry, between the two systems so that after it has been disconnected from the unsecured system into which it's data is transferred that it automatically is wiped clean of all data by a device appropriate to do so which itself cannot be corrupted by any data the memory device may contain.

The two systems with their accompanying software are necessary as is the data ferry/memory device and its conveyance mechanism and the sanitizing device which wipes it clean before it is re-connected to the secure system. None of these parts are optional except for the data ferry sanitizing device if the data ferry is constituted such that it cannot receive data from the unsecured system or the unsecured system is constituted in such a way that it cannot transfer data to the data ferry.

In other embodiments, the data ferry may be electromechanically operated or may be a solid state device having no moving parts. The data ferry may itself be physically moved between the secured and unsecured systems by the conveyance mechanism. However, the same function may be conducted by the data ferry remaining stationary and the data it conveys being transferred to it and then to the unsecured system by means of electrical gates which can be securely opened and shut. For this system to work these gates, like the data ferry sanitizing device, must be completely independent from the unsecured system, or corruption of the system could be used to control the gates such that they could allow data to pass from the unsecured system via the data ferry to the secured system. No sanitizing device for the data ferry is required if it is constituted to not be able to receive data from the unsecured system or the unsecured system is constituted so it cannot transfer data to the data ferry.

### How to Use the Invention:

Using a keyboard data router connected to a single keyboard, while monitoring the operation on a single shared monitor, the user or operator is able to cycle the data ferry between the computers as needed for the task performed. When the user wishes the convenience of networking and browsing on the Internet for purposes which are not sensitive and require no security he may use the unsecured system. He may keep few software packages on the unsecured system and clean it of unwanted code from time to time by wiping its hard drive and other components clean without having to reload many software programs.

However, when the user wishes to perform tasks for which security is desired and wishes to store software programs which cannot be easily unloaded and reloaded when a hard drive, among other memory components is cleaned, then the user can use the secured system. Whenever the user wishes to load or transfer data into the secure system he can do so through flash drives or disks for which he maintains discretion and accounting/management. Otherwise there is no way that the secured system can be penetrated or its codes or data accessed by unintended parties. Then when the user wishes to transport data from the secured system to parties outside of his computer he can instruct the data ferry conveyance system to connect the clean data ferry to the secure system so the desired data can be loaded into it. Once the data is loaded into the data ferry it [or its data] is conveyed to the unsecured system, and the data is transferred to it. When the data has been transferred to the unsecured system the data ferry disconnects automatically from the unsecured system and is wiped clean of all data by the sanitizing device. The user can use the transferred data in the unsecured system for transmittal to outside parties via email or any other means the user can instruct the unsecured system to do.

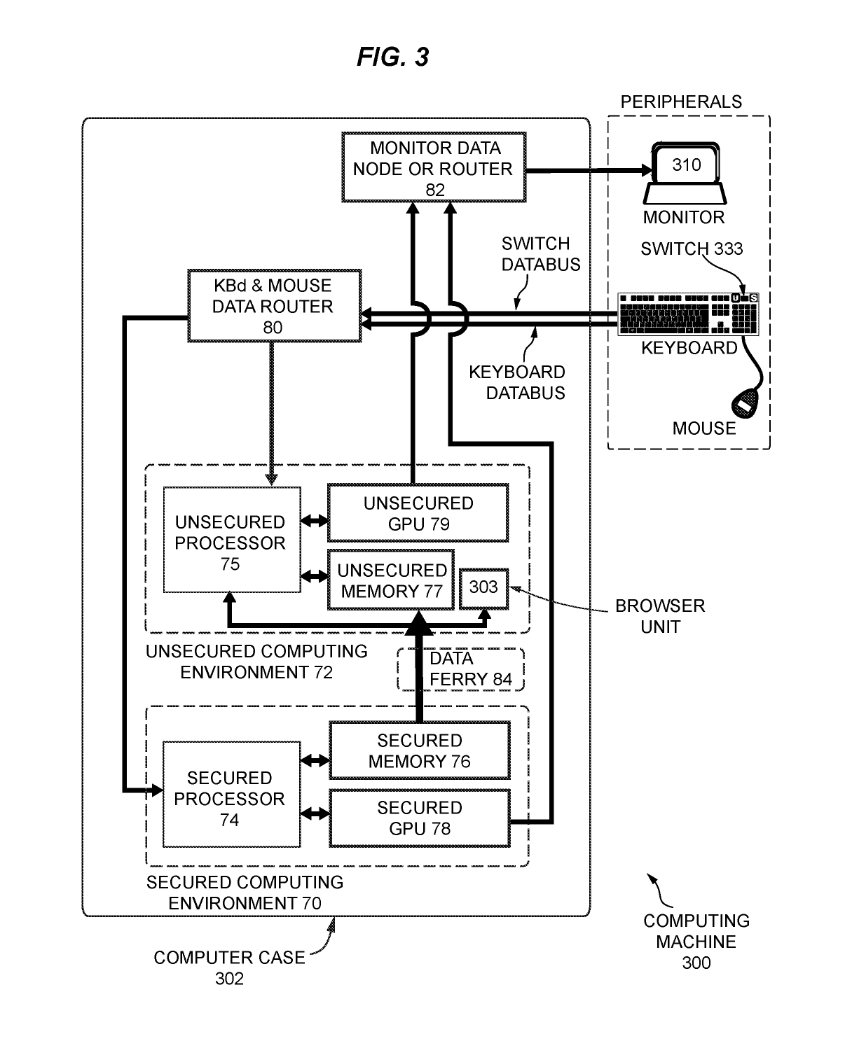

FIG. 3 is a schematic view of a computing machine 300 for use in securing network data exchanges. A single computer case 302 contains a secured or “private” computing environment 70 (that is not connected to any unsecured or public networks) and an unsecured or “browser” computer 72 (that is connectable to one or more unsecured networks such as the Internet). Each computer stands alone and includes a processor (74,75), memory (76,77) for storing data and memory with non-volatile instructions executable by the processor, and supporting logic circuitry. Each computer also includes an independent graphical processor unit (78,79) that drives a shared display 310 and a keyboard and mouse data router 80 (also termed here a “user interface data router” sensu lato, such as including a capacitive, haptic monitor interface, joystick, smart glasses for detecting eye movements, and so forth).

The selection of a computing environment to work in is made here using a switch 333 provided as part of a keyboard. Command and direction as per the operator's intent is communicated across a switch databus and is routed to the respective processors. The switch may be a single toggle having two positions, two switches, or multiple switches 333. In this instance one switch is used to direct keystrokes to the unsecured processor and another to the secured processor. The two switches may be activated simultaneously, allowing the operator to enter the same keystrokes on both core computers. Another switch in a cluster of switches may direct a data transfer event in which the operator selects a datafile or program from the secured computer directory using a mouse and then a switch key to cause the datafile to be transferred through the data ferry 84 to the unsecured computer. Alternatively, a cluster of switches may include another switch for directing the unsecured processor to display data from browser unit 303 through the monitor data router, so that the switch cluster is configured for commanding and directing both the keyboard and mouse data router 82 and also the monitor data node or router 82.

The computer case 302 is designed to house a) a keystroke data repeater/router 80 configured to route keyboard data (i.e., keystrokes) from a shared keyboard to one or both computers according to a keyboard operator's selection of a secure computing environment or an unsecure computing environment by an operator; b) a monitor data node, router 82 and/or repeater configured to send display data from the secure computing environment or the unsecure computing environment to a shared display monitor or monitors; c) a data ferry 84; and d) a networking capability (shown here as “browser unit” 303 sensu lato) connectable to the internet only through a WAN network connector in the unsecure computing environment—such that networking capability is accessible only by the browser computer. The networking capability may be wired or wireless.

The data ferry (84, and bold arrow) may include an independent core unit with processor, memory, and logic operable under control of commands from the private computer, a disconnectable data transfer connection to the private computer that is configured to receive data from the secured computing environment, and a disconnectable data transfer connection configured to transmit data to the browser computer. As described below, the data ferry may be configured in another embodiment as a data streaming device. In either instance, the operator must first select the data files to be transferred and then give a command for a data transfer. The operator may also command that programs be transferred to the browser computer and installed. Alternately, the operator can also command that the entire operating shell, root directory, or operating system of the browser computer be wiped and reinstalled using the data ferry and clean copies from the private computer. The contents of the memory transmitted to the memory 77 of the browser computer are generally a subset of the memory contained in secured memory 76. Operator commands can be stored and executed autonomously according to a regular schedule, for example, so that the browser computer is periodically restored to a trusted state and kept updated.

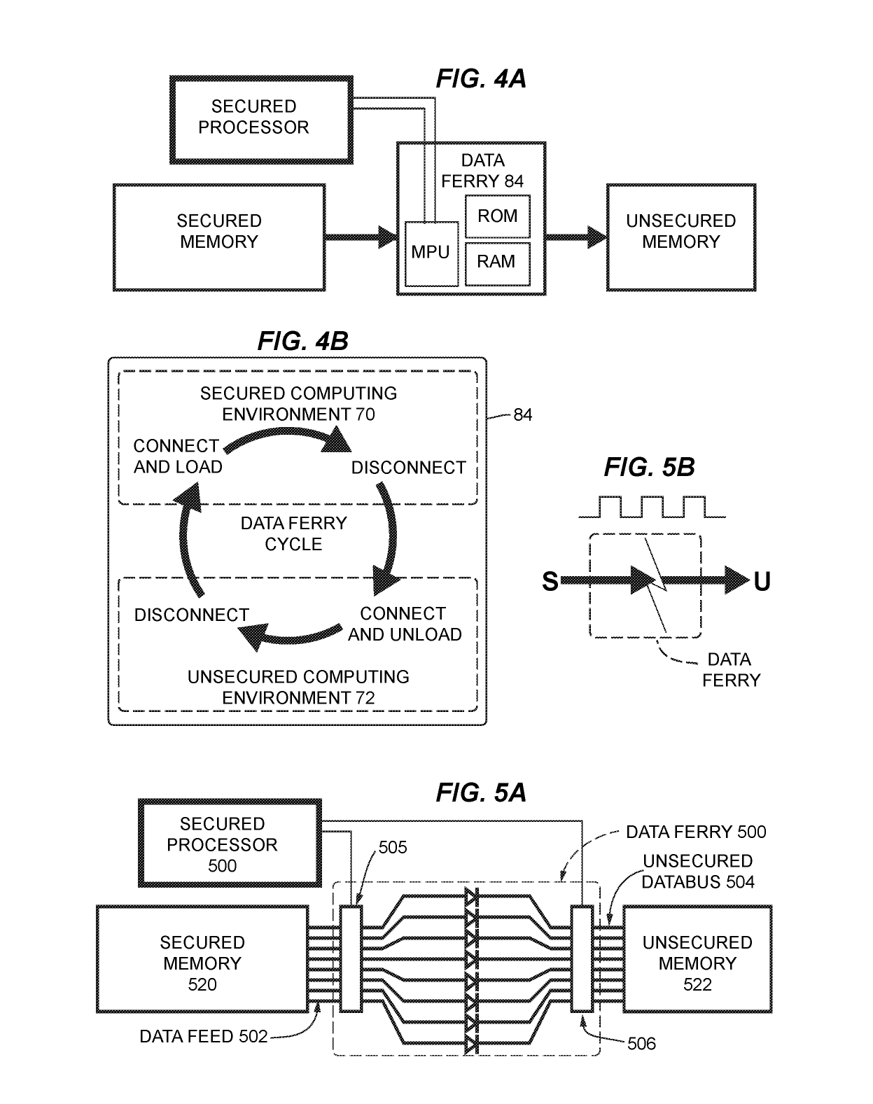

In a first embodiment, the data ferry 84 is configured to connect on command to the primary computer and to execute a rapid data transfer cycle or cycles from the primary computer to the browser computer. The IN and OUT data transfer buses and volatile memory in the data ferry are scaled to handle the needed data transfer rates (described further in FIG. 4B).

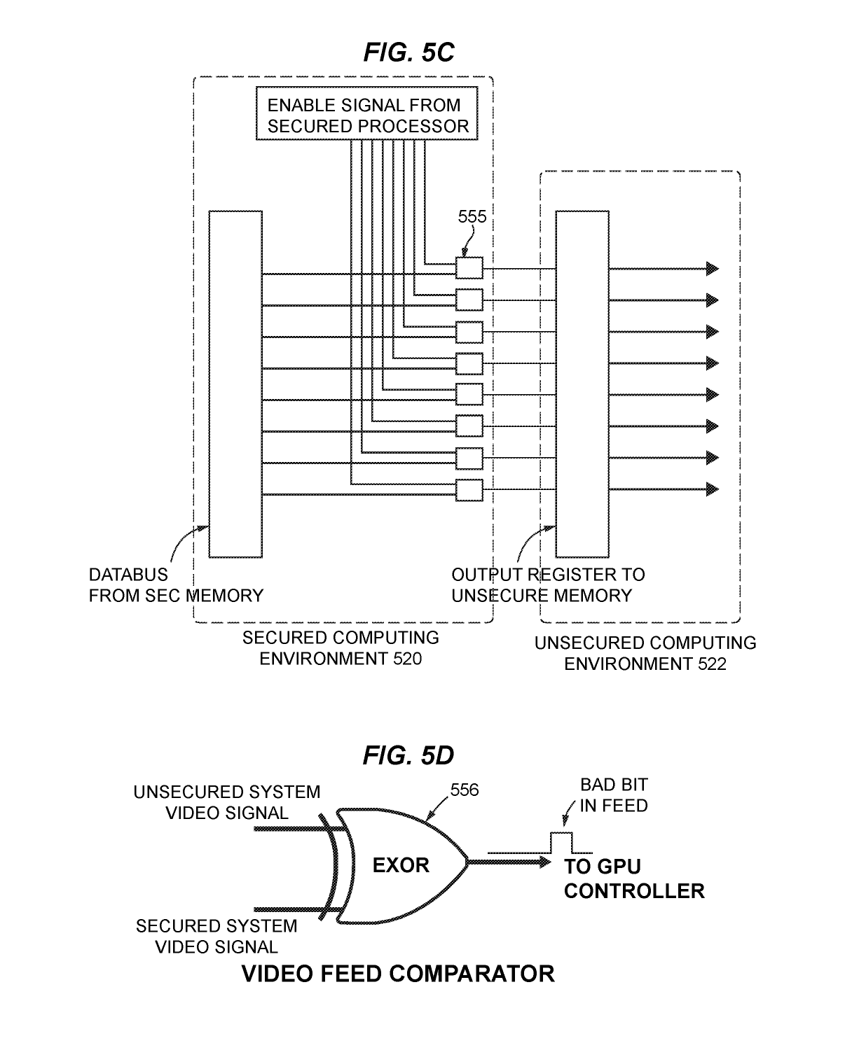

In another embodiment, by using latching registers in the private computer connected to parallel data transfer buses between the computers, transfer at high rate is achieved. As indicated by the bold arrow, streaming can be achieved by structuring the data ferry as a one-way parallel bus. Generally, a voltage drop is required to ensure that data transfer is unidirectional, and the voltage drop is achieved with diodes or enable gates (referencing FIGS. 5A-5D) in the latching data registers in a cyclical register latching process or in a continuous bitwise streaming process.

When the data ferry is a separate hardware unit mounted in the case, a power supply is provided directly from a transformer or battery. The data ferry may be configured as a latch register, an electrical diode register, or optical diode register, for example. The latching registers, a diode array, optical fibers or memory shuttle will be described in more detail below.

For a data ferry device having a volatile memory or processor with memory cache, a disconnectable data wipe connection to a sanitation device may also be provided, such that the sanitation device is configured to wipe data from the memory device or cache after each transfer cycle. The sanitation device can operate by shorting volatile memory to ground or by overwriting volatile memory.

FIG. 4A is a schematic view in which data ferry 84 is installed and operates cyclically with an onboard RAM memory. The data ferry is provided with a simple set of onboard instructions in ROM and a microprocessor (MPU) for executing those instructions cyclically. The process inside the data ferry 84 is shown in FIG. 4B involves steps for electronically or optically connecting in the secured computing environment to a secure memory, loading specified data under command of an operator (using the secured processor), disconnecting the data ferry memory from the secured memory, connecting in the unsecured computing environment to an unsecured memory and unloading the specified data, then disconnecting and continuing cyclically, or optionally returning to an intermediate disconnected state between cycles.

FIG. 5A is a data ferry having a pair of active D-latch registers (505,506) operating in series or in tandem to open and close transparently in response to high and low alternating signals (FIG. 5B) from the secured processor 500, where “S” indicates a secured system and “U” indicates an unsecured system. In each event, each D-latch device or register has an enable bit that goes high to authorize a transfer from the secured memory 520; the corresponding data bit is then transmitted to the Q output of the D-latch device or register. The data is received by the downstream register and triggers a corresponding digital bit in a data bus in the unsecured memory 522. The process operates essentially as a unidirectional GHz repeater to transmit the data feed bitwise in one and only one direction. Relevant art is described in US Pat. Appl. Nos. 2012/0017079, in which methods for hashing the data to validate transmissions, or as described in U.S. Pat. No. 5,703,562, in which optical bits can be sent unidirectionally and the operator can be signaled if data transfer is inconsistent or apparently corrupted. These patent documents are incorporated herein in full by reference. Alternatively, because the unsecured computer is dependent on the secured memory 520 for a copy of each datafile, the data is retransmitted if the operator finds a problem in the data file as received in the unsecured computer (after all, it is disposable data).

FIG. 5C illustrates the operation of a transparent latch register in a parallel 8-bit bus. For illustration, an 8-bit bus is depicted as a register of eight D-Latch devices 555. Data flow is again from left to right between a secured memory and an unsecured memory, or here to a register that functions as a repeater to launch the data bitwise into the unsecured databus (right-wise arrows). Each D-Latch acts as a gate under control of an “enable” signal from the secured processor. A corresponding output from the secured processor is sent to the unsecured processor so as to slave the appropriate memory or memory cache in the unsecured computing environment to receive the data.

Simple logic gate structures useful in streaming data across the dataferry at GHz rates and are also useful in other functions. An approach to detection of corrupted data in transfer is addressed as conceived in FIG. 5D. This would be implemented as part of the data ferry device. The device shown may be implemented on registers in the data ferry device to detect bad bits during the memory streaming process, where the secure data is essentially sent twice and the two copies of each bit are compared before the register is emptied onto the unsecured databus. Generally, corrupted files do not open or display properly, or cannot be edited on the unsecured computer, or if the data as displayed on the monitor from the unsecured GPU does not match the data from the secured GPU, then the operator will know this, or is notified.

A similar process can be implemented to compare the entire datafile as opened in its native application (such as a word processor), resulting in a video feed of a document that is displayed on a monitor. The original data is displayed on top of the display of the data copy (one display is occult). The two display feeds are compared, here titled “unsecured system video signal” and “secured system video signal”. Any bad bit may or may not deteriorate pixel by pixel or vector video fidelity, but here is detected as a bad bit output of an EXOR device (FIG. 5D). This process can be automated because the two GPU outputs can be synchronized and superimposed at an EXOR logic gate 556 for example, and any bit flop from low to high (or vice versa) at the gate output signals a “bad bit” in one of the feeds. This “video comparator” process may occur in the monitor data node or router, which may include repeater and synch circuitry coupled to a circuit for compared the input data feeds.

Both feeds need not actually be displayed to operate a video digital comparator. One feed can be displayed on the monitor while both feeds are being tested for their validity, bit versus bit. What is required is that clock synchronization be precise, and hence it is practical to construct the monitor data node 82 as a hardware unit in the computer case, the unit having one separate clock, processor and dual registers for operating the comparator.

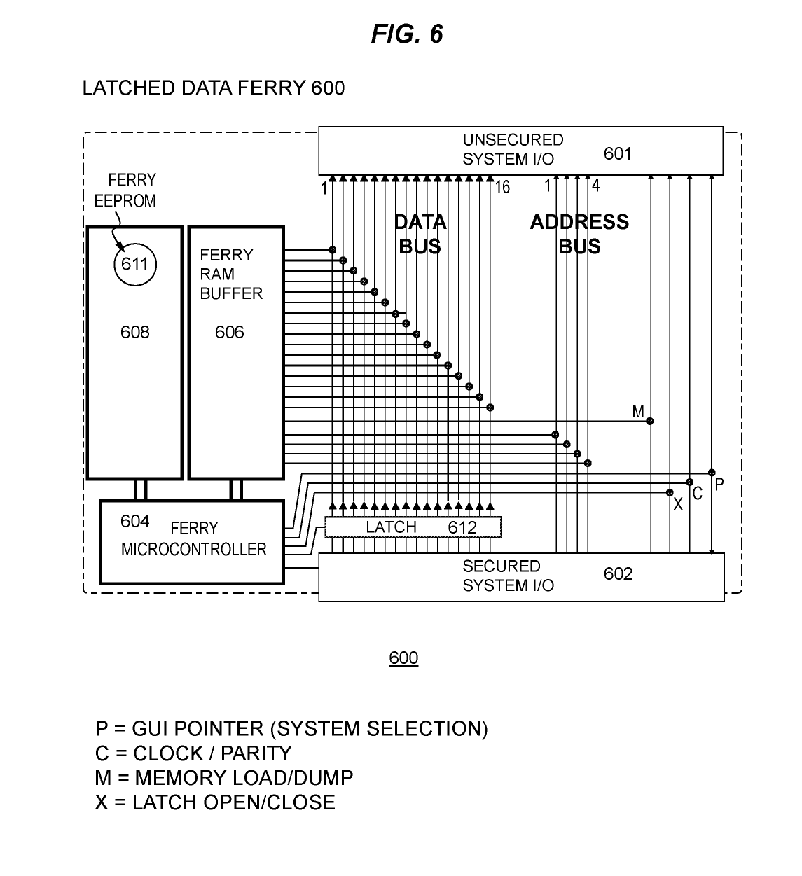

FIG. 6 is a more detailed view of a data ferry unit 600 bounded by I/O ports (601, 602: connected separately to a secured and an unsecured system, not shown). The data ferry has a separate microcontroller 604, RAM buffer memory 606, a databus, and an address bus. The address bus is a 4-bit bus for simplicity of drawing, but here the data bus is shown as a 16-bit bus emerging from latch 612 and extending to the unsecured I/O port. Data is transmitted unidirectionally through solid state latch 612 but may be stored in a RAM buffer 606. While not shown, the data ferry may include a “sanitation device” for wiping data in the RAM memory between data transfers.

Also shown are control lines from secure system I/O to an unsecured system I/O used to slave the unsecured system, (X) the latch, (C) the clock, (M) ferry RAM memory, and (P) a GUI pointer based on an operator's selection (see below). In this embodiment, the data ferry also includes EEPROM 608 containing an instruction set that is read and executed by the microcontroller 604 according to a clock signal (C) and processor instructions received from the master secure system. Unlike software, this instruction set for the data ferry is hardwired into the EEPROM, and to update or change the instruction set, a new instruction set must be burned in after first wiping the memory 611, such as is done with UV light. Hence, the capacity of a virus to infect an EEPROM is not possible without the assistance of the manufacturer and only with direct physical access to the data ferry, an unlikely event in a secured environment where case locks and intrusion alerts are easily implemented.

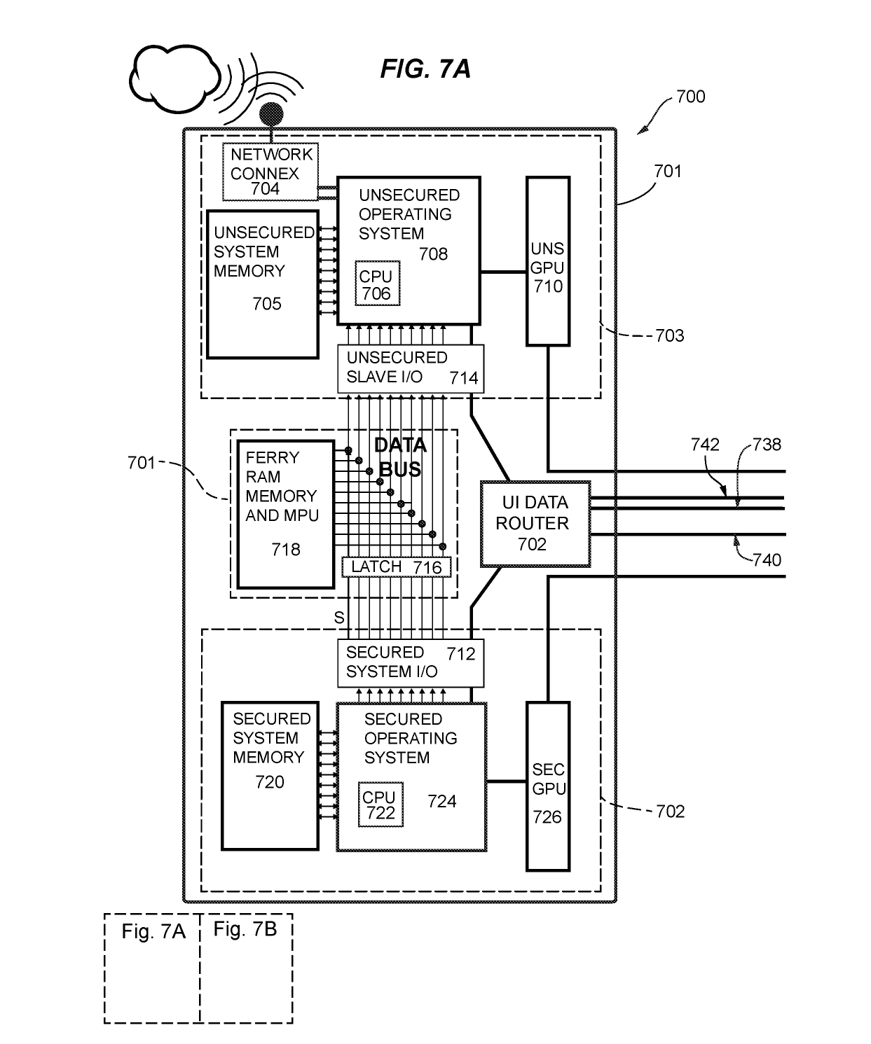

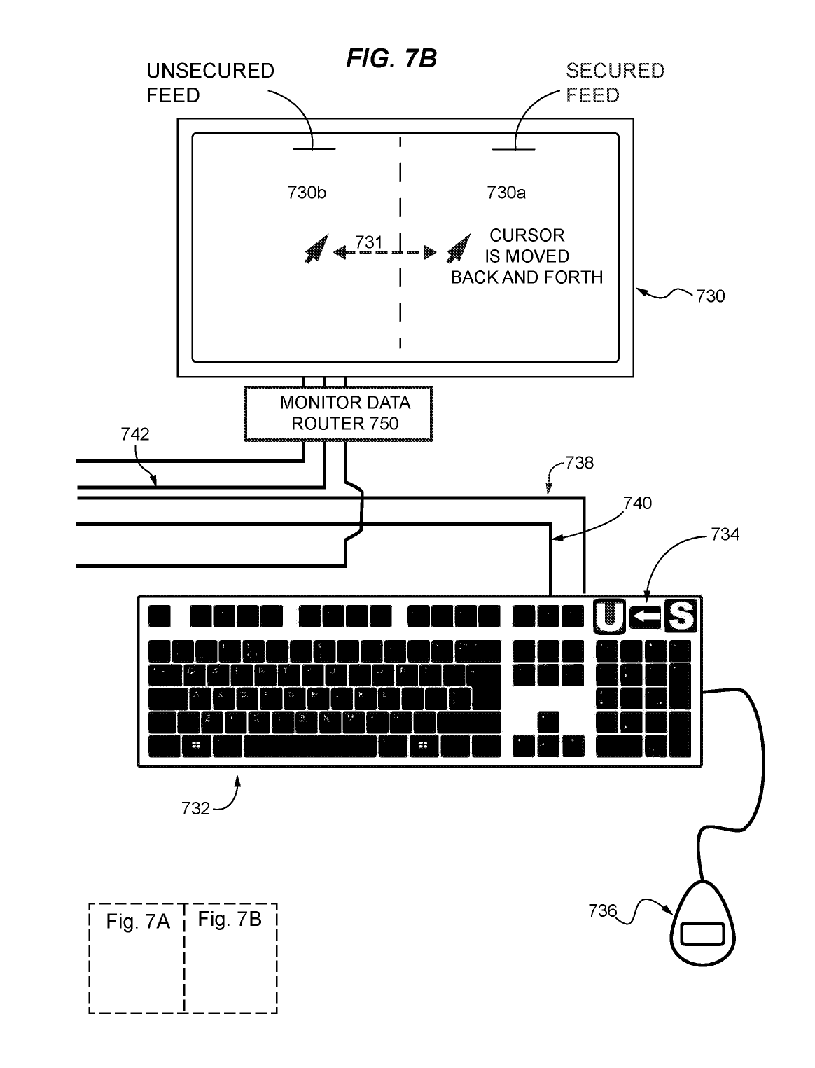

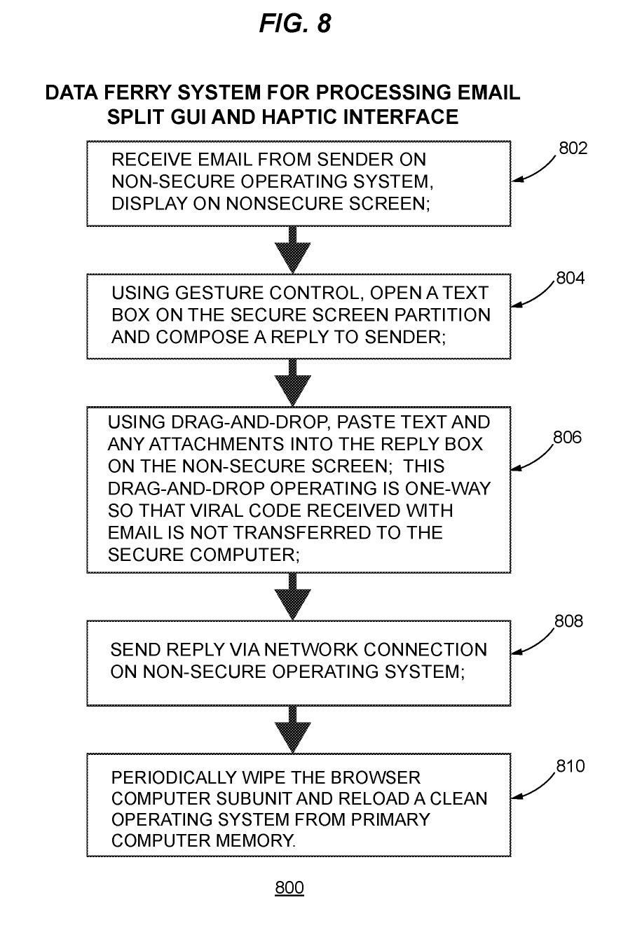

FIGS. 7A and 7B are two halves of a schematic view of a computing machine 700 in a housing 701, including peripherals. The keyboard 732 in this embodiment is configured with switches 734 used to select one of the two computers (702,703) to be “active” so that keyboard strokes and mouse movements are correctly sent to the intended computer via a user interface data router 702 (“UID router”) and a corresponding display is selected. Another switch (shown here as an arrow) can be used to control a solid state data ferry 701. Operator control is realized through keyboard databus 738, mouse databus 740, and monitor databus 742.

As before, only the unsecured computer subunit 703 has a network connection 704 to the Internet (shown here as a wireless connection). The unsecured system includes system memory 705, a processor (706, CPU) with operating system (708), and a graphics processor 710 with supporting circuitry.

The secured system 702 includes a master secure system I/O 712 that is in communication with a slave system I/O 314 in the unsecured system. These are joined by a solid state latch 716 that is configured to enable unidirectional data transfer from the secure system to data ferry RAM memory 718 and the I/O port of the unsecured system. The data ferry is shown with separate RAM here solely for illustration and can be a direct transparent data latch such as illustrated in FIG. 5C.

The secured system also includes a segregated memory 720 un-connected from the network connection, a CPU (722) and secure operating system 724 un-connected from the network connection, and a reserved GUI (726).

In the rightmost panel, FIG. 7B, a representative user interface is illustrated. Both GUIs are connected to peripherals including a monitor 330, a keyboard 332, and a mouse 334. In this instance, the monitor is divided into two virtual partitions 330a and 330b, such that the display represents the unsecured system display state and the secure system display state separately. Cursor 331 is shown to be directable between video features on the two sides of the monitor (dashed line). The keyboard 332 may be connected to either system in turn. Shown is a button switch assembly with N-Key, S-Key and arrow key 334, signifying a “Unsecured system connection” (U) and a “Secured system connection” (S). The “Arrow key” 334 enables transfer of the contents of the secure window to the non-secure window, typically with the agency of the pointer system, and is unidirectional. Also shown is a conventional mouse 336 used as a pointer.

Two 7 lines 738, 740 indicate that the keyboard is customized so that it may be connected to either system, one at a time or both together, using the U and S buttons. An exception is made for the arrow key 334 and cursor 331, that enable a user to drag content from the right screen 330b to the left screen 330b. Two lines are also provided so that independent video feed is transmitted from the GUI controllers 710,726 to the monitor, and a separate line “S” is provided to synchronize data transfer over the data bus between the two systems. RAM memory (on data ferry 718) may be included to buffer data transfer rates and to handle larger files. Generally, all lines are latched to prevent backflow of digital signals that could carry illicit code to the secure primary system.

The keyboard can also be used to forward mouse data to one or both of the computers over the UID router 702 simply by installing the mouse in a port in the keyboard and routing the mouse signal to the appropriate computer. A wireless mouse can also be detected by a Bluetooth transceiver in the keyboard and the corresponding digital signals may be sent through the keyboard router. In most instances, the UID router (for capturing keystrokes and mouse movements or clicks) is housed in the computer case as shown in FIG. 7A, but in another instance, the UID router is made part of the keyboard 732 and the transmission of keystrokes and mouse clicks to the computer case for sharing with the two computer systems is done using a wired bus in the cable connecting the keyboard to the computer motherboards or wirelessly via a radio unit mounted in the keyboard and transmitted wirelessly to receivers mounted on two separate motherboards, one for each computer.

By building a wireless UID Router, monitor data router and mouse interface, these units become part of a wireless keyboard and short range wireless transceiver such operated in a desktop MANET network, a “Piconet” wireless network, or a Bluetoothed radio network, which can be capable of auto-configuration for ease in use.

No matter how constructed, the keyboard switch 734 is illustrated to demonstrate a rudimentary circuit for doing a virtual “drag-and-drop” of a datafile onto a display partitioned into two parts, one for the secure system 730a and one for the non-secure system 730b. Alternatively, the user interface can be constructed with a haptic interface or touch-sensitive monitor and control signals can be implemented through the user interface directly rather than as a switch or switches mounted in the keyboard.

In the embodiment as shown, the monitor databus 742 is routed through a monitor data router 750. The monitor data router 750 is shown here associated with the monitor for clarity, but can be physically built into the computer case 701, into the keyboard 732, into the monitor 730, or provided separately. Generally, it may be preferred to incorporate the monitor data router as a board with connections to the GPUs (710,726) and the UID router 702.

Shown here, the monitor is in split screen mode (730a,730b), and the system is provided with a router data monitor 750 with video feeds from both the unsecured GPU 710 and secured GPU 726, and can be controlled (arrow 731) by movement of a cursor with mouse 736 or with switch 734. Surprisingly, the UID router 702 can also be used to select which data to display (on monitor 730) because the router inputs a signal or signal to both the secure and unsecure operating systems (708,724) so as to enter commands to the GPUs via I/O registers (712,714) interfacing with the secured and unsecured operating systems.

Even more surprisingly, the UID router 702 can repeat signals to both processors (706,722), allowing the operator to send keystrokes to both computers so as to mirror edits made on an open datafile to the copy of the datafile, also open, on the other computer. Both computers are presumed to contain an identical data editing program operative on the data filed as displayed and any supporting software so that this novel trick can be successfully executed. Configuring the UID router as a repeater enables the operator to send the same keystrokes simultaneously to both the secured processor 722 and the unsecured processor 706 and to periodically save the changes.

This is particularly useful in collaborations. In this system, the operator can select a split monitor window to videoconference on the unsecured computer 703 using a feed from browser network connection 704. At the same time, on a segment of the monitor screen, the operator can display an editable document. This would typically expose the document to the predations of the Internet, but by displaying a copy of the document from a video feed originating in the unsecured computing environment and editing on the display, the keyboard repeater can also enter the same keystrokes on the original of the document that is “open” in a corresponding application and stored in the secured memory. The operator can verify the changes before “saving” by switching the monitor to a view of the original document, highlighting changes and inspecting if needed, and then saving to secured memory.

FIG. 8 is a flow chart showing a general method 800 for processing email using the computing machine combination of FIGS. 7A-7B. In this example, the sequence is initiated 802 by receipt of an email from a sender on the browser computer and is displayed on a monitor. This particular monitor is partitioned into two sides, one dedicated for display of non-secure information and the other driven by a graphics card in the secured computer and dedicated for display of secure information. As suggested here, the user next composes a reply on the secured computer 804, using a keyboard transfers the text 806 by a drag-and-drop process 808 to a “reply box” on the non-secure screen. The reply box is configured to bundle the reply with the sender's message in a “thread”. The reply is then sent 810 via browser software or firmware through a network connection.

Additionally, the use of an onboard data ferry as described in the preceding examples can be used to transfer data between a secured and an unsecured processor and memory in systems that are not “computers” as classically understood, but other forms of processor-driven electronic devices that are in need for a means to isolate data from unsecured sources and data in a secured memory. A representative example of devices in need of the data ferries of the invention are “smart telephones”, personal digital assistants (PDAs), and tablets that are coming into widespread use.

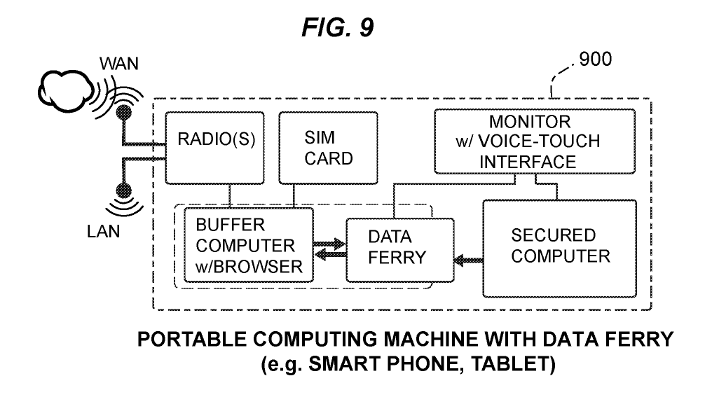

FIG. 9 is a view of a generic Internet-enabled computing machine 900, here represented by a smart phone having a data ferry device of the invention bridging a browser computer and a secured computer, in which the browser computer has an interface with a global wireless network. The network interface is shown here with a radio or radios and a SIM card and is operable with a local area network (LAN) or a wide area network (WAN). Both the data ferry and the secured computer have video controllers and display ports and the GUI display monitor is a sapphire plate with internal capacitive sensors. Also featured here is a voice recognition system that complements the touch control interface. Virtual icon technology is designed to be smart, offering a dynamic control surface based on contextual and heuristic experience with the owner of the device and can be implemented with biometric security features to complement the security provided by the data ferry.

### INCORPORATION BY REFERENCE

All of the U.S. patents, U.S. patent application publications, U.S. patent applications, foreign patents, foreign patent applications and non-patent publications referred to in this specification and related filings are incorporated herein by reference in their entirety for all purposes.

### Safe Harbor

This specification is provided in connection with a Provisional patent application filed with the United States Patent and Trademark Office, and as such includes informal sketches and copies of photographs showing exemplary embodiments of the invention. The Applicant believes that a picture is worth a thousand words, and thereby intends to disclose everything taught or suggested to one of ordinary skill in the art by the included sketches and photographs, in concert with the information otherwise disclosed herein. Applicant therefore reserves the right to articulate and teach, in words and line drawings, those features, options and uses disclosed by the sketches and photographs herein in connection with subsequent conversion of this provisional filing to a formal utility application under 37 CFR § 1.53 and 35 USC § 111(a) (or an international application) said formal application or applications having priority to this application as described under 35 USC § 119(a-e) and/or 35 USC § 365.

### SCOPE OF THE CLAIMS

The disclosure set forth herein of certain exemplary embodiments, including all text, drawings, annotations, and graphs, is sufficient to enable one of ordinary skill in the art to practice the invention. Various alternatives, modifications and equivalents are possible, as will readily occur to those skilled in the art in practice of the invention. The inventions, examples, and embodiments described herein are not limited to particularly exemplified materials, methods, and/or structures and various changes may be made in the size, shape, type, number and arrangement of parts described herein. All embodiments, alternatives, modifications and equivalents may be combined to provide further embodiments of the present invention without departing from the true spirit and scope of the invention.

In general, in the following claims, the terms used in the written description should not be construed to limit the claims to specific embodiments described herein for illustration, but should be construed to include all possible embodiments, both specific and generic, along with the full scope of equivalents to which such claims are entitled. Accordingly, the claims are not limited in haec verba by the disclosure.

I claim:

1. A computing machine for use in securing private data and programs, which comprises a computer housing that encloses:
a) a secured computer that is un-connected from all networks and
b) a browser computer that is connectable to at least one unsecured network; wherein each said computer comprises a processor, a persistent memory with instructions executable by said processor, a memory for storing data;
c) a user interface data router configured to route keyboard, mouse and monitor selection data from a shared keyboard to said secured computer and said browser computer individually;
d) a monitor data router or node configured to send display data to a shared display monitor;
e) a data ferry, wherein said data ferry comprises:
i) a latch register, electrical diode register, or optical diode register configured to effect a unidirectional data transfer of data or programs from said secured computer to said browser computer within said computer housing;
(ii) wherein said data ferry is configured to connect to said secured computer and to execute said data transfer from said secured computer to said browser computer under an operator's command and direction; and,
(f) a network capability to connect to the internet, wherein said network capability is connected to only said browser computer.

2. The computing machine of claim 1, wherein said data transfer is effected by a keyboard with keyboard router, a mouse cursor, or a gesture on a haptic interface.

3. The computing machine of claim 1, wherein said browser computer comprises an internet browser and said secured computer has no internet browser.

4. The computing machine of claim 3, wherein said browser computer comprises a browser unit.

5. The computing machine of claim 1, wherein said secured computer has a USB port, a disk burner, or other non-network connector.

6. The computing machine of claim 1, wherein a user is enabled to reversibly switch keyboard and monitor connections from said secured computer to said browser computer during regular use.

7. The computing machine of claim 1, wherein said secured computer comprises a copy of all data or code on said browser computer, and is configured to wipe said browser computer and reinstall said code through said data ferry on command or automatically.

8. The computing machine of claim 1, wherein said latch register is comprised of a parallel bus having a transparent D-latch device or devices enabled by said secured computer.

9. A method for protecting a computing system from harm, which comprises in a first instance:
a) providing a primary and a browser computer in a common housing, a monitor and a keyboard, wherein said primary and said browser computer are connected by a keyboard router or a user interface data router, a monitor router or node, and a data ferry;
b) cycling said data ferry to a first state in which said data ferry is digitally connecting to a secured computer so as to load data or code from said secured computer into said dedicated memory;
c) cycling to a second state in which said data ferry is digitally connecting to a buffer device so as to transfer data or code to said browser computer from said dedicated memory; and,
d) while cycling, switching said monitor from displaying data and switching said keyboard from entering data from said secure computer to said browser computer or from said secure computer to said browser computer in response to a command and direction indicated by an operator via said keyboard data router;
or in a second instance:
a) providing a primary and a browser computer in a common housing, a monitor and a keyboard, wherein said primary and said browser computer are connected by a keyboard router or a user interface data router, a monitor router or node, and a data ferry, said data ferry comprising executing a data transfer of a file or a program by streaming data through a latch register, electrical diode register, or optical diode register;
b) executing a data transfer of a file or a program by streaming data through said latch register, electrical diode register, or optical diode register configured to effect a unidirectional data transfer of data or programs from said secured computer to said browser computer within said computer housing;
c) after or during data transfer, switching said monitor from displaying data and switching said keyboard from entering data from said secure computer to said browser computer or from said secure computer to said browser computer in response to a command and direction indicated by an operator via said keyboard data router.

10. A computing machine for use in securing network data exchanges, which comprises a computer housing enclosing a secured computer that is un-connected from all networks and a browser computer that is connectable to at least one unsecured network; wherein each said computer comprises a processor, a persistent memory with instructions executable by said processor, a memory for storing data;
further wherein said computer housing comprises
a) a system data router configured to route keyboard data from a shared keyboard to said secured computer and said browser computer individually;
b) a monitor node, wherein said monitor node is configured to send display data to a shared display monitor;
c) a data ferry, wherein said data ferry comprises:
i) a data memory;
ii) a disconnectable data transfer connection to said secured computer;
(iii) a disconnectable data transfer connection to said browser computer;
(iv) wherein said data ferry is configured to connect on command to said secured computer and to execute a data transfer event from said secured computer to said browser computer;
(d) a network capability to connect to the internet, wherein said network capability is connected to only said browser computer.

11. The computing machine of claim 10, wherein said data transfer is effected by a keyboard with keyboard router, a mouse cursor, or a gesture on a haptic interface.

12. The computing machine of claim 10, wherein said data ferry is configured to cycle so as to load data or code into said dedicated memory when digitally connected to said secured computer in said first state; to relay data or code from said dedicated memory when digitally connected to said browser computer in said second; and, otherwise to be digitally disconnected from said secured computer and said browser computer in a third state.

13. The computing machine of claim 10, wherein said data ferry is configured to digitally disconnect from said secured computer between each said secure data transfer event.

14. The computing machine of claim 10, wherein said data ferry further comprises a sanitation device, wherein said sanitation device is configured to wipe data from said data memory after a data transfer.

15. The computing machine of claim 14, wherein said data ferry sanitation device comprises or instructions in software configured to wipe said browser computer processor of any data or code in response to a purge command or automatically in a cycle.

16. The computing machine of claim 10, wherein said browser computer comprises an internet browser and said secured computer has no internet browser.

17. The computing machine of claim 10, wherein said browser computer comprises a wireless internet communications capability and said secured computer has no wireless internet communications capability.

18. The computing machine of claim 10, wherein said secured computer has a USB port, a disk burner, or an ethernet connector to a private local router.

19. The computing machine of claim 10, wherein a user is enabled to reversibly switch keyboard and monitor connections from said secured computer to said browser computer during regular use.

20. The computing machine of claim 10, wherein said secured computer comprises an inactive copy of all data or code on said browser computer, and is configured to periodically wipe said browser computer and reinstall said code through said data ferry.
